(19) United States
(12) Patent Application Publication
(10) Pub. No.: US 2004/0031619 A1
(43) Pub. Date: Feb. 19, 2004

(54) Flexible strip cable

(75) Inventors: Holger Lettmann, Plettenberg (DE); Dean Kaminski, Dortmund (DE)

Correspondence Address: BROOKS KUSHMAN P.C., 1000 TOWN CENTER, TWENTY-SECOND FLOOR, SOUTHFIELD, MI, 48075, US

(73) Assignee: Leopold Kostal GmbH & Co., Ludenscheid (DE)

(21) Appl. No.: 10/426,594

(22) Filed: Apr. 29, 2003

Related U.S. Application Data
(63) Continuation of application No. PCT/EP02/00574, filed on Jan. 22, 2002.

(30) Foreign Application Priority Data
Jan. 27, 2001 (DE) 101 03 761.9

(51) Int. Cl. H01B 7/08

(52) U.S. Cl. 174/117 F

(57) ABSTRACT

A flexible ribbon cable includes two opposed cover sheet insulators. Each cover sheet insulator has inner and outer surfaces. Electrical conductors are arranged in parallel to one other between the inner surfaces of the cover sheet insulators. The cover sheet insulators and the electrical conductors insulated therein form a flexible ribbon cable segment. A reinforcing sheet is arranged on the outer surface of at least one of the cover sheets of at least one section of the flexible ribbon cable segment such that the at least one section of the flexible ribbon cable segment having the reinforcing sheet is relatively more protected and perhaps relatively more stiffened than remaining sections of the flexible ribbon cable segment.

### CROSS-REFERENCE TO RELATED APPLICATIONS

This is a continuation of International Application PCT/EP02/00574, published in German, with an international filing date of Jan. 22, 2002.

### BACKGROUND OF THE INVENTION

1. Field of the Invention

The present invention relates to a flexible strip or ribbon cable having multiple electrical conductors arranged parallel to one another between two insulating cover sheets. Moreover, the present invention relates to a preferred usage of a flexible ribbon cable of this sort as well as a motor vehicle winding spring cartridge equipped with such a ribbon cable. Further, the present invention relates to a method for manufacturing a flexible ribbon cable of this sort.

2. Background Art

Flexible ribbon cables include multiple electrical conductors arranged parallel to one another between two insulating cover sheets. The cover sheets are normally joined with an adhesive and thus enclose the electrical conductors between themselves. The electrical conductors are arranged with spacing between one another and are insulated from one another by a bonding agent and/or the cover sheets. The electrical conductors can be designed in terms of their profile mostly as rectangular or quadratic copper conductors or can have been applied to the lower cover sheet by means of a pressing operation.

Flexible ribbon cables of this sort are used in many applications as connecting cables, and particularly in cases where there is only a small amount of space available for installation. However, flexible ribbon cables are also used in apparatuses in which two elements which are movable with respect to one another have an electrical connection, as is the case in a winding spring cartridge of a motor vehicle.

A winding spring cartridge of this sort includes a rotor locked to a steering shaft and a stator joined to the outer steering column. The winding spring cartridge is used to produce an electrical connection between an on-board electrical supply system on the stator side and electrical/electronic components integrated in a steering wheel. Within a winding spring cartridge of this sort, the ribbon cable is wound by forming a U-shaped bend such that multiple turns around the steering wheel are possible. For this purpose, the ribbon cable is designed to be flexible. In some known winding spring cartridges, on the stator and rotor ends the ribbon cable used in the winding spring cartridge is connected to a plug-type connecting part associated with the respective part (rotor or stator).

When the winding spring cartridge is mounted on the steering post, contact occurs between corresponding plug-type connecting parts. Further winding spring cartridges are known in which on the rotor end the ribbon cable is fed out of the winding spring cartridge far enough to reach the next junction point. In a configuration of this sort, the previously described electrical junction point on the rotor of the winding spring cartridge is avoided. The ribbon cable fed out of the winding spring cartridge is divided into individual cable branches which can be brought into contact with individual connectors. The individual cable branches undergo plastic extrusion coating for protection. Moreover, a collar is required in which the section of the ribbon cable is held in which the cable branching begins. The collar is also designed to protect the ribbon cable portion it contains.

Extrusion coating of flexible work pieces, such as a relatively flexible ribbon cable as is used in a winding spring cartridge, is expensive because the individual cable branches are manually placed in the injection molds. Because it is necessary prior to extrusion coating of the individual cable branches to first process them through dividing or fanning out the ribbon cable, the handling of the individual cable branches is complicated due to their great flexibility, particularly if several such cable branches are provided on the end of the ribbon cable fed out of the winding spring cartridge.

### SUMMARY OF THE INVENTION

Based on the prior art discussed above, the underlying object of the invention is thus to further develop a flexible ribbon cable of the type named in the background introduction and to propose a method for manufacturing a flexible ribbon cable so as to allow automated sectional reinforcement of the ribbon cable.

This objective is solved through the arrangement in one or more sections of the ribbon cable of a flexible reinforcing sheet which is applied on at least one cover sheet as well as by a method which is characterized in that a step involving the joining of the cover sheets and the related enclosure of the parallel electrical conductors is followed by a step involving application of a reinforcing sheet to at least one of the cover sheets. The reinforcing sheet is applied in at least one section of the previously produced ribbon cable such that the flexibility of the ribbon cable varies between sections of the ribbon cable.

In the flexible ribbon cable according to the present invention, it is provided for protection of the cable sections which, for instance, are fed out of a winding spring cartridge to protect them by applying a reinforcing sheet on at least one of the cover sheets or on both of the cover sheets. This measure results in the reinforcement of the cover sheet insulation, but these sections are also stiffened depending on the configuration of the reinforcing sheet used. The benefit of such a ribbon cable is that the application of a reinforcing sheet, unlike the extrusion coating according to the known prior art, can be carried out with many fewer problems, and more specifically, it can be carried out before—e.g., when using such a ribbon cable in a winding spring cartridge divided into individual branches—the end of the ribbon cable with the reinforcing sheet is unraveled. Then, however, instead of unraveling a ribbon cable with very flexible characteristics, the ribbon cable is unraveled which is coated on at least one side with a reinforcing sheet. This considerably simplifies the handling.

It is particularly advantageous in a ribbon cable of this sort that the application of the at least one sectionally provided reinforcing sheet can be carried out when the ribbon cable is manufactured and thus performed using machinery already available to the manufacturer. Additional process steps of other types are basically not needed to manufacture the ribbon cable according to the present invention. A preferred (but not exclusive) application area of a ribbon cable of this sort is the use in a winding spring cartridge of a motor vehicle with the interconnection paths fed out. Moreover, the present invention provides a winding spring cartridge with a ribbon cable of this sort for this reason.

### BRIEF DESCRIPTION OF THE DRAWINGS

The present invention is described hereafter based on an exemplary embodiment and with reference to the attached figures. The figures are as follows:

FIG. 1 illustrates a schematic diagram of a device for manufacturing a flexible ribbon cable;

FIG. 2 illustrates a longitudinal section through part of a ribbon cable manufactured with the device in FIG. 1;

FIG. 3 illustrates a cross-section of the ribbon cable from FIG. 2 along the line A-B; and

FIG. 4 illustrates the ribbon cable from FIG. 2 configured for use in a winding spring cartridge of a motor vehicle.

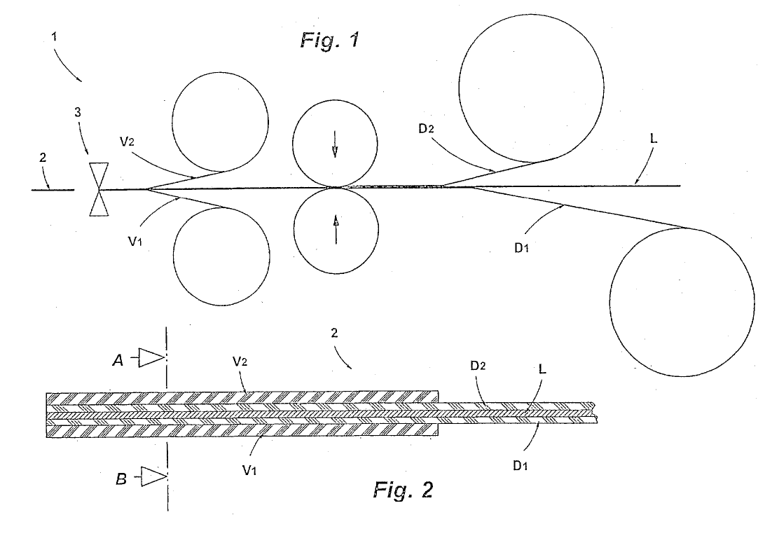

### DETAILED DESCRIPTION OF THE PREFERRED EMBODIMENT(S)

An arrangement 1 is used to manufacture a flexible ribbon cable 2 by means of a lamination process. Using arrangement 1, multiple parallel flexible electrical interconnection conductors or paths L having a quadratic or rectangular cross-sectional profile are arranged between two flexible cover sheet insulators D1, D2 Cover sheets D1, D2 are reeled off of corresponding rolls, the sides of cover sheets D1, D2 facing one another being coated with a bonding agent to enable a bond between the two cover sheets D1, D2. In a step following this lamination step, flexible reinforcing sheets V1, V2 are laminated with arrangement 1 onto each of the two cover sheets D1, D2 in sections before a length finishing of the produced ribbon cable 2 takes place in a cutting station 3.

A ribbon cable 2 produced with arrangement 1 thus includes a ribbon cable section having the two cover layers D1, D2 with electrical conductors L located between them and a further ribbon cable section in which additionally reinforcing sheets V1, V2 have been applied. This arrangement of ribbon cable 2 is shown in a sectional view in FIG. 2. In the exemplary embodiment shown, reinforcing sheets V1, V2 are located in an end section of ribbon cable 2 designated with reference number 4. In the subsequent usage of ribbon cable 2, it is provided for the ribbon cable to be divided up into individual cable branches in the area of end section 4.

The section of ribbon cable 2 without reinforcing sheets is designed to be very flexible and is provided for use in a winding spring cartridge of a motor vehicle. This section of ribbon cable 2 is accommodated in its subsequent usage in the winding spring cartridge and thus does not need any additional protection by reinforcing sheets V1, V2. It should be noted that ribbon cable 2 is flexible in the area of its end section 4 with the two reinforcing sheets V1, V2.

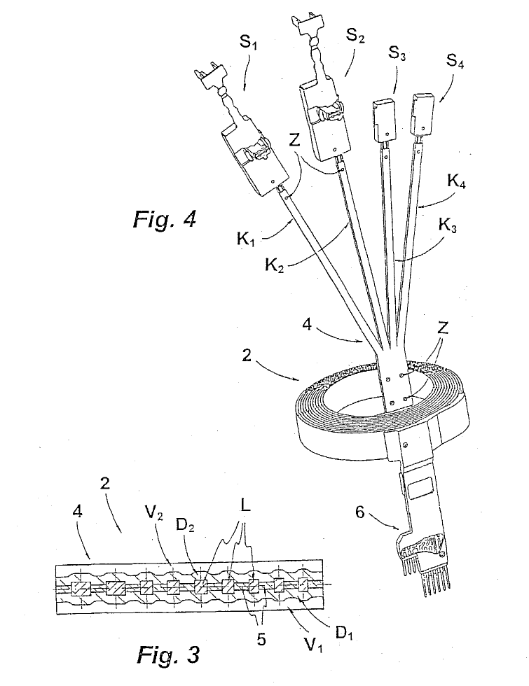

The cross-section of ribbon cable 2 shown in FIG. 3 shows once again electrical conductors L between the two cover sheets D1, D2 and reinforcing sheets V1, V2 applied on cover sheets D1, D2 in end cable section 4. Moreover, it is recognizable that an adhesive 5 is present between cover sheets D1, D2 which bonds the two cover layers D1, D2 and also insulates the two neighboring conductors L from one another.

As was mentioned above, ribbon cable 2 is intended to be installed in a winding spring cartridge of a motor vehicle (not presented in further detail) in which it is installed in roughly the arrangement shown in FIG. 4. Ribbon cable 2 is rolled up in the winding spring cartridge such that end section 4 with reinforcing sheets V1, V2 defines the outgoing circuit on the rotor side.

The other end of ribbon cable 2 represents the outgoing circuit on the stator side; on this end the ribbon cable 2 is equipped with a connector part 6. The end section 4 feeds out of the actual winding spring cartridge on the rotor side so that the connecting line for making contact with the next plug-type connection is implemented through this end section 4 simultaneously. In the end section 4, ribbon cable 2 is divided up to form the individual cable branches K1-K4 which can then be connected individually to the different connectors.

A plug-type connecting part S1-S4 is applied to the end of each cable branch K1-K4 The dividing up of ribbon cable 2 in the area of end section 4 is arranged so that a lower area that is not divided up remains, in which ribbon cable 2 is also coated with reinforcing sheets V1, V2. In this area and also in the area of each free end of a cable branch K1-K4, strain relief openings Z are introduced. In a configuration that is not shown in particularity, it is provided that also the connection on the stator side of the winding spring cartridge is formed corresponding to the end section 4 so as to be able to dispense with the interface formed by the connector part 6.

As is shown by the example of a usage in a winding spring cartridge, the ribbon cable according to the present invention can be used advantageously in applications in which flexible ribbon cables are needed with flexibility that varies from section to section of the ribbon cable.

Reference list:

| | |
|---|---|
| 1 | Arrangement for manufacturing a ribbon cable |
| 2 | Ribbon cable |
| 3 | Cutting station |
| 4 | End section |
| 5 | Bonding agent |
| 6 | Connector part |
| D1, D2 | Cover sheet |
| K1-K4 | Cable branch |
| L | Interconnection path |
| S1-S4 | Plug-type connecting part |
| V1, V2 | Reinforcing sheet |
| Z | Strain relief opening |

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A flexible ribbon cable comprising:
two opposed cover sheet insulators, each cover sheet insulator having an inner surface and an outer surface;
a plurality of electrical conductors arranged in parallel to one other between the inner surfaces of the cover sheet insulators, the inner surfaces of the cover sheet insulators insulating the electrical conductors from one another, wherein the cover sheet insulators and the electrical conductors insulated therein form a flexible ribbon cable segment; and
a reinforcing sheet arranged on the outer surface of at least one of the cover sheets of at least one section of the flexible ribbon cable segment such that the at least one section of the flexible ribbon cable segment having the reinforcing sheet is relatively more protected than remaining sections of the flexible ribbon cable segment.

2. The cable of claim 1 wherein:
the at least one section of the flexible ribbon cable segment having the reinforcing sheet is divided into individual cable branches.

3. The cable of claim 1 further comprising:
strain relief openings in the at least one section of the flexible ribbon cable segment having the reinforcing sheet.

4. The cable of claim 1 wherein:
the reinforcing sheet is arranged on the outer surfaces of both of the cover sheet insulators of the at least one section of the flexible ribbon cable segment.

5. The cable of claim 1 wherein:
the reinforcing sheet has a stiffness such that the at least one section of the flexible ribbon cable segment is relatively more stiff than the remaining sections of the flexible ribbon cable segment.

6. A flexible ribbon cable for a winding spring cartridge of a motor vehicle, the cable comprising:
two opposed cover sheet insulators, each cover sheet insulator having an inner surface and an outer surface;
a plurality of electrical conductors arranged in parallel to one other between the inner surfaces of the cover sheet insulators, the inner surfaces of the cover sheet insulators insulating the electrical conductors from one another, wherein the cover sheet insulators and the electrical conductors insulated therein form a cable segment; and
a reinforcing sheet arranged on the outer surface of at least one of the cover sheets of one end section of the cable segment such that the end section of the cable segment having the reinforcing sheet is relatively more protected than the remaining section of the cable segment;
wherein the remaining section of the cable segment is wound-up to be placed in a winding spring cartridge;
wherein the end section of the cable segment is fed out from the wound-up remaining section of the cable segment and is divided up into individual cable branches, the individual cable branches each having ends with respective electrical connecting means thereon.

7. The cable of claim 6 wherein:
the reinforcing sheet has a stiffness such that the one end section of the cable segment is relatively more stiff than the remaining section of the cable segment.

8. A flexible ribbon cable for a winding spring cartridge of a motor vehicle having a rotor and a stator, the cable comprising:
two opposed cover sheet insulators, each cover sheet insulator having an inner surface and an outer surface;
a plurality of electrical conductors arranged in parallel to one other between the inner surfaces of the cover sheet insulators, the inner surfaces of the cover sheet insulators insulating the electrical conductors from one another, wherein the cover sheet insulators and the electrical conductors insulated therein form a cable segment; and
a reinforcing sheet arranged on the outer surface of at least one of the cover sheets of one end section of the cable segment such that the end section of the cable segment having the reinforcing sheet is relatively more protected than the remaining section of the cable segment;
wherein the remaining section of the cable segment is wound-up to be placed in a winding spring cartridge, wherein one end of the remaining section is for connection to a stator of the motor vehicle;
wherein the end section of the cable segment is fed out from the other end of the wound-up remaining section of the cable segment for connection to the rotor of the motor vehicle.

9. The cable of claim 8 wherein:
the end section of the cable segment fed out from the other end of the wound-up remaining section of the cable segment is divided up into individual cable branches, the individual cable branches each having ends with respective electrical connecting means thereon for connection to the rotor of the motor vehicle.

10. A method for manufacturing a flexible ribbon cable, the method comprising:
providing two opposed cover sheet insulators, each cover sheet insulator having an inner surface and an outer surface;
providing a plurality of electrical conductors arranged in parallel to one another;
joining the two opposed cover sheet insulators with the electrical conductors arranged in parallel to one other between the inner surfaces of the cover sheet insulators such that the inner surfaces of the cover sheet insulators insulating the electrical conductors from one another, wherein the cover sheet insulators and the electrical conductors insulated therein form a flexible ribbon cable segment; and
applying a reinforcing sheet on the outer surface of at least one of the cover sheets of at least one section of the flexible ribbon cable segment such that the at least one section of the flexible ribbon cable segment having the reinforcing sheet is relatively more protected than remaining sections of the flexible ribbon cable segment.

11. The method of claim 10 further comprising:
dividing the at least one section of the flexible ribbon cable segment having the reinforcing sheet into individual cable branches.

12. The method of claim 10 wherein:
the reinforcing sheet has a stiffness such that the at least one section of the flexible ribbon cable segment is relatively more stiff than the remaining sections of the flexible ribbon cable segment.
